(19) United States
(12) Patent Application Publication
(10) Pub. No.: US 2010/0026094 A1
(43) Pub. Date: Feb. 4, 2010

(54) DC POWER SYSTEM

(75) Inventors: Rudy Kraus, Newtown, CT (US); Peter Gross, Santa Monica, CA (US)

Correspondence Address: WILDMAN HARROLD ALLEN & DIXON LLP, 225 WEST WACKER DRIVE, SUITE 2800, CHICAGO, IL, 60606, US

(73) Assignee: VALIDUS DC SYSTEMS, LLC, Brookfield, CT (US)

(21) Appl. No.: 12/518,138

(22) PCT Filed: Dec. 7, 2007
(86) PCT No.: PCT/US07/25119

§ 371 Date: Jul. 24, 2009

Related U.S. Application Data
(60) Provisional application No. 60/873,857, filed on Dec. 8, 2006.

(51) Int. Cl. H02J 1/10

(52) U.S. Cl. 307/29

(57) ABSTRACT

There is provided a system that includes a power feed that distributes a direct current (DC) voltage in a building. The DC voltage is In a range of about 300-600 volts DC. The system also includes a motor, and a motor drive. The motor drive receives the DC voltage via the power feed, and from the DC voltage, derives an output that drives the motor.

### BACKGROUND OF THE INVENTION

1. Field of the Invention

The present invention relates to a highly reliable, redundant direct current (DC) power system that provides modulated power to motors that are utilized in the cooling of data centers and critical infrastructures.

2. Description of the Related Art

Critical infrastructures like data centers, telecommunications center and others that require high density critical uptime power for processing storage and communications have been steadily growing with regard to their power and cooling requirements. In these critical infrastructure applications, it is imperative to not only supply highly reliable power, but also equally reliable cooling. If cooling were to fail for even a small period of time the computer equipment could be severely affected. Additionally, due to the extreme energy use of these centers, it is imperative to design and apply systems that are not only resilient but also highly efficient.

Traditionally, the power delivered to motors that provide the movement of fluid and/or air in data centers has been provided by either a utility company or by a stand-by generator when the utility is not viable. With an increase in the power required to operate data center equipment, and its associated heat, the necessity of providing uninterruptible power to the pumps and fans motors during a power outage has become a primary concern. While the alternating current (AC) power to the computers in a data center is bridged by use of a battery backup system during a utility outage, the essential motors pumps, fans and compressors are typically allowed to go off line until a generator assumes the load of the center. This process, from utility power outage until the load is transferred to generators, can take up to 60 seconds and in some cases longer, thereby leaving the critical cooling systems off line for a dangerously long period of time. With the advent of today's higher density data centers where the critical loads (processors, storage and communications devices) are backed up by a battery system and stay on line, the cooling systems do not stay online, potentially causing the critical loads to overheat and in some instances damage occurs. It is not prudent to place pumps, fans, compressors or motors on a dedicated uninterruptible power supply system as the computing equipment may be exposed to poor line quality and/or noise.

### SUMMARY OF THE INVENTION

There is provided a system that includes a power feed that distributes a direct current (DC) voltage in a building. The DC voltage is in a range of about 300-600 volts DC. The system also includes a motor, and a motor drive. The motor drive receives the DC voltage via the power feed, and from the DC voltage, derives an output that drives the motor.

### BRIEF DESCRIPTION OF THE DRAWINGS

FIG. 1 is a schematic of a redundant DC power system

### DESCRIPTION OF THE INVENTION

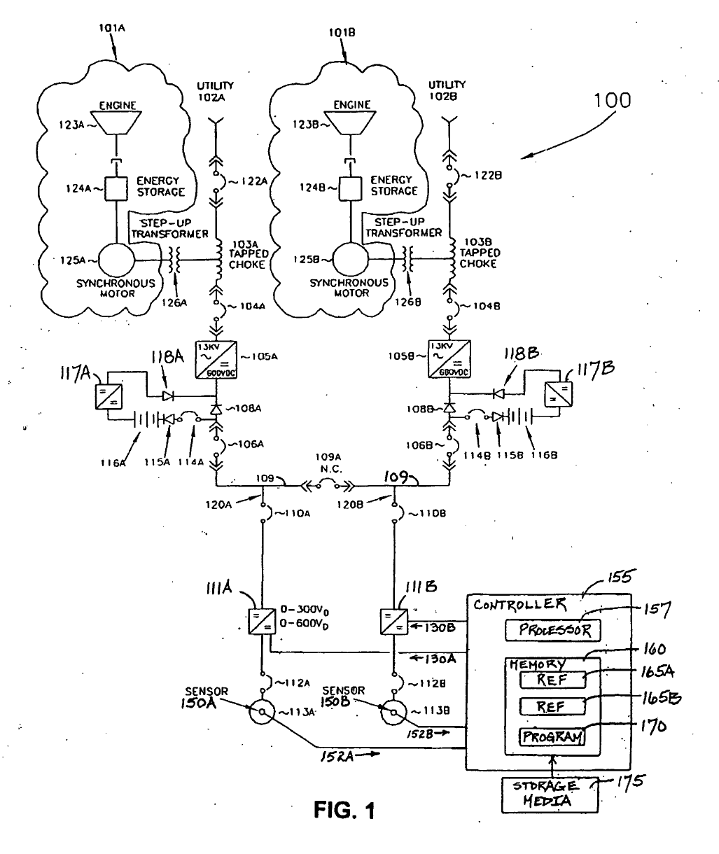

FIG. 1 is a schematic of a redundant DC power system, i.e., system 100. System 100 is configured as a 2N power system, where N is the amount of power required to properly support power loads. System 100 includes generators 101A, B, rectifiers 105A, B, motor drives 111A, B, motors 113A, B, sensors 150A, B, and a controller 155.

In brief, system 100 provides DC power to motor drives 111A, B, that in turn drive motors 113A, B. Via sensors 150A, B, controller 155 monitors parameters associated with the operation of motors 113A, B, and in turn controls motor drives 111A, B so that the sensed parameters are maintained within a desired range.

System 100 receives alternating current (AC) from utilities 102A, B. The AC current from utility 102A is coupled through a breaker 122A, and the AC current from utility 102B is coupled through a breaker 122B. Breakers 122A, B protect circuits downstream of breakers 122A, B, and can be implemented as either circuit breakers or fuses.

Generator 101A provides emergency power in a case of a power outage of utility 102A. Generator 101A is configured as a combination of an engine, for example, a diesel engine 123A coupled to an energy storage device 124A, e.g., a flywheel, that is in turn coupled to a synchronous motor 125A. Diesel engine 123A is an energy source that, when engaged, generates an AC output. Energy storage device 124A captures energy in the form of the AC output of the diesel engine 123A, and holds this energy in reserve for discharge at an onset of a power emergency. Synchronous motor 125A is essentially a generator which provides an AC voltage that is stepped up to a higher AC voltage, e.g., 13 KV, through a step-up transformer 126A.

Generator 101B provides emergency power in a case of a power outage of utility 102A, and is configured as a combination of a diesel engine 123B coupled to an energy storage device 124B, that is in turn coupled to a synchronous motor 125B. The output of synchronous motor 125B is stepped up through a step-up transformer 126B. Generator 101B, diesel engine 123B, energy storage device 124B, synchronous motor 125B, and step-up transformer 126B function similarly to generator 101A, diesel engine 123A, energy storage device 124A, synchronous motor 125A, and step-up transformer 126A, respectively.

A tapped choke 103A couples power from either utility 102A or step-up transformer 126A to a load downstream of tapped choke 103A. When power is available from utility 102A, tapped choke 103A couples power from utility 102A. When a power outage of utility 102A occurs, tapped choke 103A uncouples utility 102A from the load and, and instead, receives power from step-up transformer 126A. Similarly, a tapped choke 103B receives power from utility 102B and step-up transformer 126B, and couples the power to a load downstream of tapped choke 103B.

Rectifier 105A receives AC current from tapped choke 103A via a breaker 104A. Similarly, rectifier 105B receives AC current from tapped choke 103B via a breaker 104B. Breakers 104A, B protect rectifiers 105A, B and other circuits downstream of breakers 104A, B, and may be implemented as either circuit breakers or fuses.

As mentioned above, if utilities 102A, B are not available, the power will be delivered to rectifiers 105A, B from generators 101A, B, respectively. Generators 101A, B can be various sizes and voltages necessary to match the characteristics of the utility 102A, B normally feeding the inputs of rectifiers 105A, B.

Rectifiers 105A, B utilize power from utilities 102A, B or generators 101A, B and rectify such power to provide a DC output, e.g., 300-600 volts DC (VDC). The DC output of rectifier 105A is coupled through a diode 108A and a breaker 106A to a bus 109. Similarly, the DC output of rectifier 105B is coupled through a diode 108B and a breaker 106B to bus 109. Breakers 106A, B protect circuits downstream of breakers 106A, B, and may be implemented as either circuit breakers or fuses.

Rectifiers 105A, B each include an electrical filter (not shown) on the input side of rectifiers 105A, B to reduce a negative effect of reflected harmonics onto bus 109, motor drives 111A, B, motor 113A, B or motor controller 155. Output stabilization of the DC output rectifiers 105A, B will also be passively attenuated by a capacitance and an inductance in the form a tuned filter within the DC outputs of rectifiers 105A, B.

The DC outputs of rectifiers 105A, B are “OR-gated” or bridged together through diodes 108A, B to bus 109. That is, power can be supplied to bus 109 by either rectifier 105A or rectifier 105B, or by both of rectifier 105A and rectifier 105B simultaneously.

In addition, each of rectifiers 105A, B have a control panel (not shown) that provides an operator with the ability to change the DC output voltages of rectifiers 105A, B. This allows for the DC output voltages of rectifiers 105A, B to be varied so that either rectifier 105A or rectifier 105B can supply a higher voltage than the other rectifier 105A,B, thus allowing the highest of the two voltages to feed bus 109, and the lowest of the two voltages to become a secondary redundant feed if the highest feed were to fail. Rectifiers 105A, B can be applied either as a unit of one or in units of two or more (parallel) to produce greater amounts of power or redundancy.

System 100 also includes diodes 118A, B, chargers 117A, B, batteries 116A, B, diodes 115A, B, and breakers 114A, B. During normal operation of rectifier 105A, DC current flows through diode 118A to charger 117A, which, in turn, charges battery 116A. Diode 108A and diode 115A “OR” the outputs of rectifier 105A and battery 116A. In a case of a loss of power from rectifier 105A, battery 116A provides DC power through diode 115A and breaker 114A, to bus 109. Similarly, during normal operation of rectifier 105B, DC current flows through diode 118B to charger 117B, which, in turn, charges battery 116B. Diode 108B and diode 115B “OR” the outputs of rectifier 105B and battery 116B. In a case of a loss of power from rectifier 105B, battery 116B provides DC power through diode 115B and breaker 114B, to bus 109.

Batteries 116A, B, by way of example, can be any energy storage vehicle such as a kinetic flywheel, a fuel cell, or a capacitor. Breakers 114A, B protect circuits downstream of breakers 114A, B, and may be implemented as either circuit breakers or as fuses.

Bus 109 is routed as a DC power feed that provides a DC voltage, e.g., 300-600 VDC, in a building. That is, bus 109 is routed through the building so that devices or subsystems that require DC power can obtain the DC power via bus 109.

Bus 109 feeds the DC voltage to buses 120A and 120B. Bus 120A provides power, via a breaker 110A, to motor drive 111A, and bus 120B provides power, via breaker 110B, to motor drive 111B. Breakers 110A, B protect circuits downstream of breakers 110A, B, and may be implemented as either circuit breakers or fuses.

A switch 109A enables the isolation of rectifier 105A and motor drive 111A from rectifier 105B and motor drive 111B for service or maintenance. More specifically, when switch 109A is opened circuitry on the left side of switch 109A, e.g., rectifier 105A and motor drive 111A, is isolated from circuitry on the right side of switch 109A, e.g., rectifier 105B and motor drive 111B.

As mentioned above, the outputs of rectifiers 105A, B, are “OR-gated” For example, assume that rectifier 105A is higher in voltage than rectifier 105B, and that switch 109A is closed. Because switch 109A is closed, current from diode 108A feeds motor drives 111A and 111B. If the voltage from rectifier 105A drops to a voltage equal to that of rectifier 105B, rectifier 105B will share the load equally with rectifier 105A. If the voltage from rectifier 105A drops below that of rectifier 105B, rectifier 105B will feed motor drives 111A, B.

Motor drive 111A receives the DC voltage via bus 120A, and from the DC voltage derives an output that drives, i.e., provides power for, motor 113A via a breaker 112A. Similarly, motor drive 111B receives the DC voltage via bus 120B, and from the DC voltage derives an output that drives, i.e., provides power for, motor 113B via a breaker 112B. Breakers 112A, B protect motors 113A, B, and other circuits downstream of breakers 112A, B, and can be implemented as either circuit breakers or fuses.

Motors 113A, B are installed in equipment such as chillers, computer room air conditioners, fans, pumps or compressors, and are utilized to move air, water or any other cooling medium. Motors 113A, B can be installed separately from one another, or be used together to provide redundancy in a piece of equipment or redundancy in an environment that requires critical cooling. For example, with regard to the redundancy, motors 113A and 113B can both be situated in a computer room so that if either motor 113A or motor 113B fails, the other motor 113A or 113B will still be available.

Motors 113A, B can be either DC motors or AC motors. A DC motor's speed and torque is directly related to its input voltage. The greater the voltage the faster the speed, and the lower the voltage the slower the speed. Thus, the speed of a DC motor is controlled by varying the input voltage to the DC motor. An AC motor's speed is directly related to its input voltage frequency. The higher the frequency the faster the speed, and the lower the frequency the slower the speed. Thus, the speed of an AC motor is controlled by varying the frequency of the input voltage to the AC motor.

In a case where motor 113A is a DC motor, motor drive 111A will provide a DC voltage to motor 113A. In a case where motor 113A is an AC motor, motor drive 111A will provide an AC voltage to motor 113A. Similarly, motor drive 111B will drive motor 113B with either a DC voltage or an AC voltage.

Sensor 150A senses a parameter relating to the operation of motor 113A, and outputs a parameter value 152A indicative thereof. The parameter can be any suitable parameter, but examples include (i) speed of motor 113A, and (ii) temperature of an environment being cooled by a cooler that is driven by motor 113A. Similarly sensor 150B senses a parameter relating to the operation of motor 113B, and outputs parameter value 152B. Controller 155 monitors parameter values 152A and 152B, and controls motor drives 111A, B so that parameter values 152A and 152B are maintained within a desired range.

When motor 113A is a DC motor, motor drive 111A is implemented as a DC to DC motor drive, and controller 155 causes the output voltage of motor drive 111A to vary, to control motor 113A. The output voltage range of motor drive 111A may be any suitable range, but exemplary ranges are 0-300 VDC or 0-600 VDC. When motor 113A is an AC motor, motor drive 111A is implemented as a DC to AC motor drive, and controller 155 causes the output frequency of motor drive 111A to vary, to control motor 113A. The output frequency may be any suitable range, but an exemplary range is 0-60 Hertz (Hz).

The output of motor drive 111A is varied by controlling a switching operation, e.g., switching rate or duty cycle, of a circuit contained therein. The circuit can be implemented, for example, using an insulated gate bipolar transistor (IGBT), a silicon controlled rectifier (SCR), or a metal oxide semiconductor field effect transistor (MOSFET). Accordingly, controller 155 provides a control signal 130A to motor drive 111A to vary the switching rate or duty cycle, thereby adjusting the output voltage or frequency from motor drive 111A, and thus the rate of change and speed of motor 113A. The speed and torque of motor 113A produces an amount of work. A parameter relating to this work is sensed by sensor 150A and parameter value 152A is transmitted to controller 155.

Motor drive 111B operates similarly to motor drive 111A. Thus, sensor 150B transmits parameter value 152B to controller 155, which provides a control signal 130B to motor drive 111B, which in turn controls motor 113B.

Controller 155 includes a processor 157 and a memory 160 that contains a module of instructions, e.g., program 170, for controlling processor 157. Memory 160 also contains a reference value 165A and a reference value 165B for parameter values 152A and 152B, respectively. With regard to the operation of motor 113A, controller 155, and more particularly, processor 157, compares parameter value 152A to reference value 165A, and based on a result of the comparison, sends control signal 130A to motor drive 111A, which, in turn, adjusts the speed of motor 113A so that parameter value 152A satisfies reference value 165A. Similarly, controller 155 compares parameter value 152B to reference value 165B, and based on a result of the comparison, sends control signal 130B to motor drive 111B, which, in turn, adjusts the speed of motor 113B so that parameter value 152B satisfies reference value 165B.

For example, assume that motor 113A drives a compressor in an air conditioner in a room. Sensor 150A senses a temperature of the room and, in the form of parameter value 152A, reports the temperature to controller 155. Controller 155 compares the sensed temperature to a reference value, e.g., reference value 165A, and based on the comparison, sends control signal 130A to motor drive 111A. Motor drive 111A, in response to control signal 130A, adjusts an operation of motor 113A so that the temperature in the room does not exceed the reference value.

Although controller 155 is described herein as having program 170 installed into memory 160, program 170 can be embodied on a storage media 175 for subsequent loading into memory 160. Storage media 175 can be any computer-readable storage media, such as, for example, a floppy disk, a compact disk, a magnetic tape, a read only memory, or an optical storage media. Program 170 could also be embodied in a random access memory, or other type of electronic storage, located on a remote storage system and coupled to memory 160.

Also, although program 170, reference value 165A and reference value 165B are described herein as being installed in memory 160, and therefore being implemented in software, they could be implemented in any of hardware, firmware, software, or a combination thereof.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A system comprising:
a power feed that distributes a direct current (DC) voltage in a building, wherein said DC voltage is in a range of about 300-600 volts DC;
a motor; and
a motor drive that receives said DC voltage via said power feed, and from said DC voltage, derives an output that drives said motor.

2. The system of claim 1, further comprising:
a first source of said DC voltage; and
a second source of said DC voltage,
wherein said first source and said second source are bridged together to provide said DC voltage to said power feed.

3. The system of claim 1, further comprising:
a sensor that senses a parameter relating to an operation of said motor, and provides a parameter value indicative thereof; and
a controller that performs a comparison of said parameter value to a reference value, and based on said comparison, outputs a signal that controls said motor drive to, in turn, control said output that drives said motor.

4. The system of claim 3,
wherein said output of said motor drive is related to a switching operation of a circuit of said motor drive, and
wherein said signal from said controller controls said switching operation to control said output of said motor drive.

5. The system of claim 4, wherein said switching operation is selected from the group consisting of a switching rate and a duty cycle.

6. The system of claim 4,
wherein said motor is an alternating current (AC) motor,
wherein said output of said motor drive is an AC voltage, and
wherein said signal from said controller controls said switching operation to control a frequency of said output of said motor drive.

7. The system of claim 4,
wherein said motor is a DC motor,
wherein said output of said motor drive is a DC voltage, and
wherein said signal from said controller controls said switching operation to control a voltage level of said output of said motor drive.

8. The system of claim 1, wherein said motor is a component of a piece of equipment selected from the group consisting of a chiller, an air conditioner, a fan, a pump and a compressor.

9. The system of claim 1,
wherein said motor is a first motor, and said motor drive is a first motor drive,
wherein said system further comprises:
a second motor; and
a second motor drive that receives said DC voltage via said power feed, and from said DC voltage, derives an output that drives said second motor, and
wherein said first and second motors are configured in a redundant relationship, and employed in a cooling operation.
